(19) United States
(12) Patent Application Publication
(10) Pub. No.: US 2025/0095655 A1
(43) Pub. Date: Mar. 20, 2025

(54) IDENTITY RECOGNITION METHOD, APPARATUS, COMPUTER DEVICE, AND STORAGE MEDIUM

(71) Applicant: ZJU-HANGZHOU GLOBAL SCIENTIFIC AND TECHNOLOGICAL INNOVATION CENTER, Hangzhou (CN)

(72) Inventors: Feng LIN, Hangzhou (CN); Tiantian LIU, Hangzhou (CN); Chao WANG, Hangzhou (CN); Hao YAN, Hangzhou (CN); Kui REN, Hangzhou (CN)

(21) Appl. No.: 18/509,329

(22) Filed: Nov. 15, 2023

(30) Foreign Application Priority Data
Sep. 18, 2023 (CN) 202311209049.3

(51) Int. Cl. G10L 17/10; G01S 13/32; G10L 17/02; G10L 17/20; G10L 21/0232; G10L 25/78

(52) U.S. Cl. CPC G10L 17/10; G01S 13/32; G10L 17/02; G10L 17/20; G10L 21/0232; G10L 25/78

(57) ABSTRACT

An identity recognition method, an apparatus, a computer device, and a storage medium are provided. The method includes: obtaining a signal to be identified which includes a millimeter wave signal and an audio signal; performing living feature detection based on the millimeter wave signal and the audio signal, and acquiring a living millimeter wave signal and a living audio signal; performing feature fusion of the living millimeter wave signal and the living audio signal, and acquiring a fusion response diagram of a living voice signal; and performing identity recognition based on the fusion response diagram of the living voice signal.

### CROSS-REFERENCE TO RELATED APPLICATIONS

This application claims priority to Chinese patent application No. 202311209049.3, filed on Sep. 18, 2023, the content of which is hereby incorporated by reference in its entirety.

### TECHNICAL FIELD

The present disclosure generally relates to the field of voiceprint authentication, and in particular, to an identity recognition method, an apparatus, a computer device, and a storage medium.

### BACKGROUND

With development of voiceprint authentication technology, as a way to identify legal users, the voiceprint authentication lets the users get rid of constraints of memorizing passwords and auxiliary gestures. Unity of command and verification can be achieved as long as through voice. The voiceprint authentication with convenient and user-friendly characteristics is widely concerned and used in all sectors of society, such as smart speakers, financial systems, and access control. High robustness and high security are basic properties that corresponding voice control system should have. In the related art, pure voiceprint authentication system usually adopts single-mode voiceprint authentication algorithm, but due to inherent propagation nature of sound waves, it is easy to be subjected to malicious spoofing attacks, in addition to replay attacks and imitation attacks which are easy to operate by attackers, counter attack may be launched, so that the pure voiceprint authentication system will mistake counter disturbance signal for the user registered in a user database. In addition, under influence of environmental noise, authentication accuracy will also decrease.

In the related art, researchers proposed a multimodal voiceprint authentication system to address risks and deficiencies of the pure voiceprint authentication systems. The multimodal voiceprint authentication system integrates additional complementary modes, such as gestures, WIFI, images, and electrocardiograms, to integrate multiple characteristics of the user to identify the user. However, these methods only consider single-mode attacks against speech, ignoring multi-mode attacks against speech and other modes. In most multimodal voiceprint authentication systems, additional complementary modes are independently developed and utilized, ignoring internal correlation related to speech. When encountering interference such as motion interference or light change, overall system authentication performance deteriorates. Recognition that integrates with speech, such as gestures or electrocardiograms, requires the users to perform specific actions, which greatly limits user experience.

Therefore, a way to resist malicious spoofing attacks and improve authentication accuracy is urgently needed.

### SUMMARY

For the issue of the above problem, the present disclosure provides an identity recognition method, an apparatus, a computer device, and a storage medium to resist malicious spoofing attacks and improve authentication accuracy.

In a first aspect, the present disclosure provides an identity recognition method, including: obtaining a signal to be identified which includes a millimeter wave signal and an audio signal;
performing living feature detection based on the millimeter wave signal and the audio signal, and acquiring a living millimeter wave signal and a living audio signal;
performing feature fusion of the living millimeter wave signal and the living audio signal, and acquiring a fusion response diagram of a living voice signal; and
performing identity recognition based on the fusion response diagram of the living voice signal.

In an embodiment, before the performing living feature detection based on the millimeter wave signal and the audio signal, and acquiring the living millimeter wave signal and the living audio signal, the method further includes:
performing voice activity detection of the millimeter wave signal and the audio signal, and acquiring a millimeter wave signal and an audio signal with voice activity; and
performing denoising of the millimeter wave signal and the audio signal with voice activity, and acquiring a denoised millimeter wave signal and a denoised audio signal.

In an embodiment, the performing voice activity detection of the millimeter wave signal and the audio signal, and acquiring the millimeter wave signal and the audio signal with voice activity further includes:
sampling the millimeter wave signal and the audio signal, and acquiring sampled millimeter wave signals and sampled audio signals;
obtaining a phase of the sampled millimeter wave signals and determining phase difference between sampled millimeter wave signals with the same frequency; and
performing low-pass filtering based on the phase difference and the sampled audio signals, and acquiring the millimeter wave signal and the audio signal with voice activity.

In an embodiment, the performing denoising of the millimeter wave signal and the audio signal with voice activity, and acquiring the denoised millimeter wave signal and the denoised audio signal further includes:
decomposing the millimeter wave signal and the audio signal with voice activity, and acquiring millimeter wave sub-signals and audio sub-signals;
calculating correlation based on the millimeter wave sub-signals and the audio sub-signals, and screening the millimeter wave sub-signals and the audio sub-signals based on the correlation; and
recombining screened millimeter wave sub-signals and screened audio sub-signals, and acquiring the denoised millimeter wave signal and the denoised audio signal.

In an embodiment, the performing living feature detection based on the millimeter wave signal and the audio signal, and acquiring the living millimeter wave signal and the living audio signal further includes:
extracting living feature of millimeter wave and living feature of audio based on the millimeter wave signal and the audio signal, respectively;
calculating similarity coefficients based on the living feature of millimeter wave and the living feature of audio, and generating a dual-mode reference signal based on the similarity coefficients; and
inputting the dual-mode reference signal into a classification model, acquiring the living millimeter wave signal and the living audio signal, and the classification model being trained by using a standard data set.

In an embodiment, the performing feature fusion of the living millimeter wave signal and the living audio signal, and acquiring the fusion response diagram of the living voice signal further includes:
generating a millimeter wave response diagram and an audio response diagram based on the living millimeter wave signal and the living audio signal, respectively; and
fusing the millimeter wave response diagram and the audio response diagram, and acquiring the fusion response diagram of the living voice signal.

In an embodiment, the performing identity recognition based on the fusion response diagram of the living voice signal further includes:
inputting the fusion response diagram of the living voice signal into an identity recognition network, acquiring an identity label of the user, and the identity recognition network including a channel attention module and a spatial attention module.

In a second aspect, the present disclosure further provides an identity recognition apparatus, which includes:
means for obtaining a signal to be identified which comprises a millimeter wave signal and an audio signal;
means for performing living feature detection based on the millimeter wave signal and the audio signal, and acquiring a living millimeter wave signal and a living audio signal;
means for performing feature fusion of the living millimeter wave signal and the living audio signal, and acquiring a fusion response diagram of a living voice signal; and
means for performing identity recognition based on the fusion response diagram of the living voice signal.

In a third aspect, the present disclosure further provides a computer device. The computer device includes a processor and a memory, the memory stores a computer program, and the computer program is executable by the processor to implement the steps of the identity recognition method in the above embodiments.

In a fourth aspect, the present disclosure further provides a computer-readable storage medium having stored a computer program, the computer program is executable by a processor to implement the steps of the identity recognition method in the above embodiments.

### BRIEF DESCRIPTION OF THE DRAWINGS

FIG. 1 is a diagram of an application environment of an identity recognition method in an embodiment.

FIG. 2 is a flowchart diagram of an identity recognition method in an embodiment.

FIG. 3 is a flowchart diagram of a denoising processing in an embodiment.

FIG. 4 is a schematic diagram of acquiring a fusion response diagram of a living voice signal in an embodiment.

FIG. 5 is a flowchart diagram of a specific implementation step of an identity recognition method in an embodiment.

FIG. 6 is a block diagram of a structure of an identity recognition apparatus in an embodiment.

FIG. 7 is an internal structure diagram of a computer device in an embodiment.

### DETAILED DESCRIPTION OF THE EMBODIMENT

In order to make purposes, technical solutions and advantages of the present disclosure more clearly understood, the present disclosure is described in further detail below in conjunction with the accompanying drawings and embodiments. It should be understood that the specific embodiments described herein are for the sole purpose of explaining the present disclosure and are not intended to limit the present disclosure.

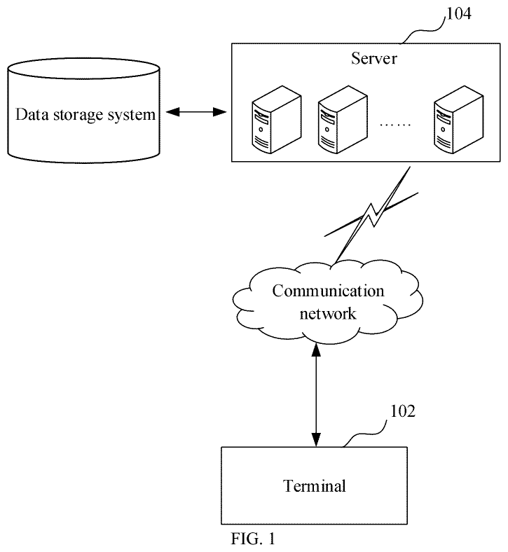

An identity recognition method provided in the present disclosure may be applied in an application environment shown in FIG. 1. A terminal 102 may be in communication with a server 104 by a network. A data storage system may store data to be processed by a server 104. The data storage system may be integrated in the server 104 or may be placed in a cloud or other network server. The terminal 102 may be, but is not limited to, a variety of personal computers, laptops, smartphones, tablets, Internet of Things (IoT) devices, and portable wearable devices, and the IoT devices may be a smart speaker, a smart TV, a smart air conditioner, a smart in-vehicle device, and the like. The portable wearable devices may be a smart watch, a smart bracelet, a headband device, and the like. The server 104 may be realized with a standalone server or a server cluster including a plurality of servers.

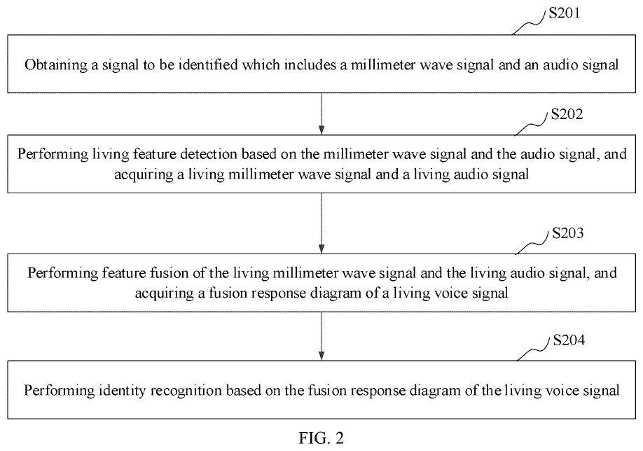

In an embodiment, referring to FIG. 2, an identity recognition method is provided, which is illustrated as an example of the identity recognition method applied to the server of FIG. 1. The identity recognition method includes step 201 to step 204.

Step 201 includes obtaining a signal to be identified which includes a millimeter wave signal and an audio signal.

In the present embodiment, the signal to be identified is obtained, which includes the millimeter wave signal and the audio signal. The millimeter wave signal is acquired by a millimeter wave radar, the audio signal is acquired by a microphone, and both the millimeter wave radar and the microphone can pick up real signals of voice activity and other uncorrelated signals. Specifically, for acquiring of the millimeter wave signal, the millimeter wave radar may receive an echo signal, normalize and scale the echo signal to acquire a frequency modulation (FM) continuous wave signal, process the FM continuous wave signal by fast Fourier transform of distance and obtain distance information of a sound emitting object, detect the object by statistical ordered Constant False Alarm Rate Detection technology, reflect fast Fourier transform points of the object, extract phase based on the fast Fourier transform points, and finally constitute the millimeter wave signal. After the millimeter wave signal and the audio signal are acquired, the millimeter wave signal and the audio signal are split into 3 seconds frames with 50% overlap between consecutive frames, and normalized scaling is performed, respectively, to unify value ranges of the millimeter wave signal and the audio signal.

Step 202 includes performing living feature detection based on the millimeter wave signal and the audio signal, and acquiring a living millimeter wave signal and a living audio signal.

In the present embodiment, after obtaining the millimeter wave signal and the audio signal, the living feature detection is performed on the millimeter wave signal and the audio signal. A living feature of the millimeter wave signal is related to a biological tissue feature of human skin, and a living feature of the audio signal is related to an acoustic organ feature. The living feature detection is performed based on the living feature to identify whether both the millimeter wave signal and the audio signal are from real living signals, remove fake signals or fake data streams therein, and retain the living millimeter wave signal and the living audio signal.

Step 203 includes performing feature fusion of the living millimeter wave signal and the living audio signal, and acquiring a fusion response diagram of a living voice signal.

After performing living feature detection on the millimeter wave signal and the audio signal, it is necessary to extract human-specific features for identity recognition. In the related cross-modal recognition system, fusion technology merely combines two modal data for parallel processing, usually ignores discordant irrelevant information between heterogeneous modalities and fails to make full use of cross-modal correlation to enhance fusion features, and produces a phenomenon of interference noise drowning out user identity feature information in multimodal features, leading to a reduction of recognition accuracy. Therefore, in the embodiment of the present disclosure, based on the living millimeter wave signal and the living audio signal, a correlation filter may be employed to process the living millimeter wave signal and the living audio signal to generate a response diagram that measures quality of features. The correlation filter may track and learn effective features of a target by frame streams, and the target may be a spectral energy trajectory of the living audio signal or the living millimeter wave signal. The correlation filter may model a region of interest and generate a response diagram to track target change in time and space, and thereafter, generate fusion features based on the response diagram, and acquire an enhanced fusion response diagram of the living voice signal.

Step 204 includes performing identity recognition based on the fusion response diagram of the living voice signal.

Related fusion mechanisms, such as a voting mechanism, may select better results from outputs processed by multiple independent systems. The voting mechanism may seem like a convenient way in which loss of information in one of the modes can be compensated for. However, when the user remotely invokes an identity recognition function based on fusion of the voting mechanism in a noisy environment, it is often impossible to recognize two signals because the two signals are often simultaneously contaminated. A long-distance propagation may lead to causing degradation of audio signal-to-noise ratio, and ubiquitous multipath noise may impose additional noise shielding on useful information of the millimeter wave signal, in which case a simple voting mechanism cannot provide a practical voice identity recognition application. Therefore, in the embodiment of the present disclosure, an attention mechanism may be employed, which is widely developed and utilized in Deep Neural Networks (DNNs) to improve learning and representation capabilities of the network. Specifically, an attentional residual network may be employed to perform recognition by cross-modal fusion of fusion features in the fusion response diagram of the living voice signal, and ultimately output identity of the user.

In the above identity recognition method, the method includes obtaining a signal to be identified which includes a millimeter wave signal and an audio signal; performing living feature detection based on the millimeter wave signal and the audio signal, and acquiring a living millimeter wave signal and a living audio signal; performing feature fusion of the living millimeter wave signal and the living audio signal, and acquiring a fusion response diagram of a living voice signal; and performing identity recognition based on the fusion response diagram of the living voice signal. In other words, in response to malicious spoofing attacks in voice identity recognition and authentication scenarios, a response diagram that measures quality of data information is constructed by extracting voiceprint-aware data on an audio modality and living data on the human skin surface which is wirelessly sensed, to realize identity recognition, resist malicious spoofing attacks, and improve authentication accuracy of voiceprint recognition at the same time.

In an embodiment, before the performing living feature detection based on the millimeter wave signal and the audio signal, and acquiring the living millimeter wave signal and the living audio signal, the method may further include step 301 and step 302.

Step 301 may include performing voice activity detection of the millimeter wave signal and the audio signal, and acquiring a millimeter wave signal and an audio signal with voice activity.

Step 302 may include performing denoising of the millimeter wave signal and the audio signal with voice activity, and acquiring a denoised millimeter wave signal and a denoised audio signal.

In the present embodiment, the acquired millimeter wave signal and audio signal may include signals related to voice activities of the user and signals that are not related to the voice activities of the user, as well as ambient noise and body movement, etc. Therefore, preliminary processing may be carried out to remove irrelevant interference therein. Firstly, the voice activity detection of the millimeter wave signal and the audio signal may be performed. Difference between the noise and the voice signal in a frequency domain may be employed to obtain the millimeter wave signal and the audio signal with voice activity by coherent demodulation. Then, the denoising of the millimeter wave signal and the audio signal with voice activity may be performed by common characteristics of a millimeter wave mode and a voice mode in sensing the voice activity, and the irrelevant interference may be removed, so as to acquire the denoised millimeter wave signal and the denoised audio signal.

In the present embodiment, the voice activity detection of the millimeter wave signal and the audio signal may be performed to acquire the millimeter wave signal and the audio signal with voice activity, and denoising of the millimeter wave signal and the audio signal with voice activity may be performed to acquire the denoised millimeter wave signal and the denoised audio signal. This may ensure high quality of an input signal source, selecting sub-signals relevant to voice activity and eliminating extraneous clutter components, and improving noise immunity.

In an embodiment, the performing voice activity detection of the millimeter wave signal and the audio signal, and acquiring the millimeter wave signal and the audio signal with voice activity may further include step 401 to step 403.

Step 401 may include sampling the millimeter wave signal and the audio signal, and acquiring sampled millimeter wave signals and sampled audio signals.

Step 402 may include obtaining a phase of the sampled millimeter wave signals and determining phase difference between sampled millimeter wave signals with the same frequency.

Step 403 may include performing low-pass filtering based on the phase difference and the sampled audio signals, and acquiring the millimeter wave signal and the audio signal with voice activity.

In an embodiment, the millimeter wave signal and the audio signal may be sampled, respectively. A pre-processed millimeter wave signal may be up-sampled to 16 kHz by linear interpolation, a pre-processed audio signal may be down-sampled to 16 kHz by signal extraction, so as to acquire the sampled millimeter wave signals and the sampled audio signals denoted as v(n). Then, the fast Fourier transform may be employed to obtain the phase denoted as ϕ(n) of the sampled millimeter wave signals, phase difference denoted as Δϕ(n) between sampled millimeter wave signals with the same frequency may be calculated based on the phase, and a calculating formula is as follows.

Δϕ(n)=ϕ(n)−ϕ(n−1)

Since the phase difference and the sampled audio signal have frequency correlation properties, i.e., both the phase difference and the sampled audio signal are related to the voice activity, the phase difference Δϕ(n) and the sampled audio signals v(n) may be multiplied together, and a low-pass frequency filter may be employed to perform low-pass filtering. A cut-off frequency of the low-pass frequency filter may be set to 300 Hz, i.e., only the phase difference Δϕ(n) and the sampled audio signals v(n) with frequencies that are lower than the cut-off frequency would pass through. When the phase difference Δϕ(n) and the sampled audio signals v(n) have the same or similar frequency components, a low-frequency energy peak would be obtained. When a spectral entropy of the low-frequency energy peak is greater than a given threshold, it means that a vocal cord vibration is recorded by the phase difference Δϕ(n) and the sampled audio signals v(n) at the same time, which indicates that voice activity occurs. When the spectral entropy of the low-frequency energy peak is less than the given threshold, it means that a received signal fragment does not contain voice activity, then the signal may be discarded without subsequent processing operations. The given threshold may be summarized experimentally, alternatively, e.g., 0.835. Even if the noise corrupts the audio signal or the millimeter wave signal, or even worse both the audio signal and the millimeter wave signal, the coherent demodulation may be still effective due to difference between the noise and the voice signal in the frequency domain.

In the present embodiment, the millimeter wave signal and the audio signal may be sampled to acquire sampled millimeter wave signals and sampled audio signals, the phase of the sampled millimeter wave signals may be obtained and phase difference between sampled millimeter wave signals with the same frequency may be determined, low-pass filtering may be performed based on the phase difference and the sampled audio signals, and the millimeter wave signal and the audio signal related to voice activity of the user may be acquired. This may ensure high quality of received signals.

In an embodiment, the performing denoising of the millimeter wave signal and the audio signal with voice activity, and acquiring the denoised millimeter wave signal and the denoised audio signal may further include step 501 to step 503.

Step 501 may include decomposing the millimeter wave signal and the audio signal with voice activity, and acquiring millimeter wave sub-signals and audio sub-signals.

Step 502 may include calculating correlation based on the millimeter wave sub-signals and the audio sub-signals, and screening the millimeter wave sub-signals and the audio sub-signals based on the correlation.

Step 503 may include recombining screened millimeter wave sub-signals and screened audio sub-signals, and acquiring the denoised millimeter wave signal and the denoised audio signal.

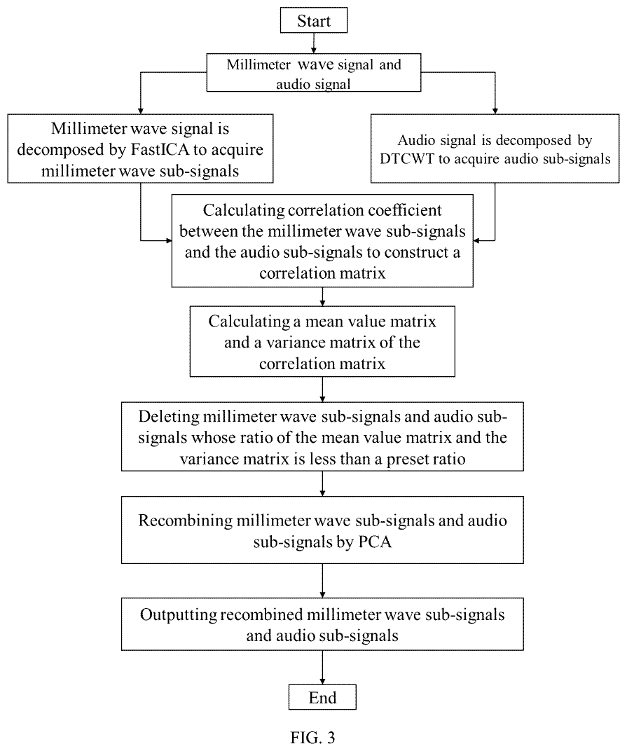

In an embodiment, referring to FIG. 3, the millimeter wave signal and the audio signal with voice activity may be decomposed by Fast Independent Component Analysis (FastICA) and Dual-Tree Complex Wavelet Transform (DTCWT), respectively, to acquire a series of millimeter wave sub-signals and audio sub-signals. The correlation based on the millimeter wave sub-signals and the audio sub-signals may be calculated. Alternatively, Pearson correlation coefficient may be chosen to assess the correlation, and the Pearson correlation coefficient refers to a quotient of a covariance and a standard deviation of two variables. A correlation matrix may be constructed based on the Pearson correlation coefficient, the correlation matrix may contain cross-modal information, where higher coefficients indicate stronger correlation between the corresponding sub-signals. Stronger correlation means that the millimeter wave sub-signals contain voice vibrations, while the audio sub-signals record voice activity and are not irrelevant noise. Then a mean value matrix and a variance matrix may be determined based on the correlation matrix, and a ratio of the mean value matrix and the variance matrix may be calculated, i.e., the mean value matrix/the variance matrix. Millimeter wave sub-signals and audio sub-signals that satisfy the ratio greater than a preset ratio may be selected to retain, and the greater the ratio is, the larger average energy is. After a large number of experiments and analyses, the preset ratio may be usually set as 5. The mean value matrix may be obtained by calculating a mean value of each column of the correlation matrix, and the variance matrix may be acquired by calculating a variance of each row of the correlation matrix. After that, the screened millimeter wave sub-signals and the screened audio sub-signals may be recombined by Principal Component Analysis (PCA) to generate reconstructed signals to acquire the denoised millimeter wave signal and the denoised audio signal.

In the present embodiment, the millimeter wave signal and the audio signal with voice activity may be decomposed to acquire the millimeter wave sub-signals and the audio sub-signals, the correlation may be calculated based on the millimeter wave sub-signals and the audio sub-signals, the millimeter wave sub-signals and the audio sub-signals may be screened based on the correlation, the screened millimeter wave sub-signals and the screened audio sub-signals may be recombined to acquire the denoised millimeter wave signal and the denoised audio signal. This may remove irrelevant interference, such as environmental noise and body movement, and ensure high quality of the received signal.

In an embodiment, the performing living feature detection based on the millimeter wave signal and the audio signal, and acquiring the living millimeter wave signal and the living audio signal may further include step 601 to step 603.

Step 601 may include extracting living feature of millimeter wave and living feature of audio based on the millimeter wave signal and the audio signal, respectively.

Step 602 may include calculating similarity coefficients based on the living feature of millimeter wave and the living feature of audio, and generating a dual-mode reference signal based on the similarity coefficients.

Step 603 may include inputting the dual-mode reference signal into a classification model, acquiring the living millimeter wave signal and the living audio signal, and the classification model is trained by using a standard data set.

In an embodiment, a short-time Fourier transform may be performed on the audio signal to obtain an audio spectrum, the converted audio spectrum may be segmented into low-frequency components and high-frequency components within an audible range, constant frequency cepstral coefficients originating from acoustic organ features may be extracted from the low-frequency components and the high-frequency components, and the frequency cepstral coefficients may be the living feature of the voice that indicate biological activity. For the millimeter wave signal, a square device may be employed to process reflected mid-frequency millimeter wave to obtain a DC (Direct Current) component, i.e., a low-frequency signal, which is the living feature of millimeter wave. When the millimeter wave signal arrives at a human body, due to a limited depth of sub-millimeter penetration, electromagnetic radiation may be mainly confined to a human skin, and an amplitude of the millimeter wave signal may be subject to heterogeneous attenuation due to difference in heterogeneous permittivity determined by biological tissues of the human skin. The attenuation may be determined by a reflectance coefficient of the human body, retain biologically active characteristics and differentiate from malignant signals of manmade imitation.

After that, the similarity coefficients may be calculated based on the living feature of millimeter wave and the living feature of audio, and the following formula may be employed for calculation.

$${S}_{M} = \frac{M \times {M}_{T}}{\sqrt{{M}^{2} \times {M}_{T}^{2}}} , {S}_{V} = \frac{V \times {V}_{T}}{\sqrt{{V}^{2} \times {V}_{T}^{2}}}$$

S_{M} represents the similarity coefficient of the living feature of millimeter wave, S_{V} represents the similarity coefficient of the living feature of audio, M represents the living feature of millimeter wave, M_{T} represents a standard living feature of millimeter wave, V represents the living feature of audio, and V_{T} represents a standard living feature of audio.

After that, the dual-mode reference signal may be generated based on the similarity coefficients, which is mainly based on the following formula.

$$C = min ( \vert log \frac{{S}_{M}}{\sqrt{{S}_{M}}} \vert , \vert log \frac{{S}_{V}}{\sqrt{{S}_{V}}} \vert )$$

Finally, the dual-mode reference signal may be input into the classification model, the living millimeter wave signal and the living audio signal may be acquired from a real living body, and alternatively, the classification model may be a class of classification support vector machines obtained by pre-training using a standard data set.

In the present embodiment, living feature of millimeter wave and living feature of audio may be extracted based on the millimeter wave signal and the audio signal, respectively, similarity coefficients based on the living feature of millimeter wave and the living feature of audio may be calculated, and the dual-mode reference signal may be generated based on the similarity coefficients, and the dual-mode reference signal may be input into the classification model to acquire the living millimeter wave signal and the living audio signal. This may recognize and distinguish signals from real user and malicious spoofing signals, resist all kinds of malicious attacks, and increase reliability and security of voiceprint recognition.

In an embodiment, the performing feature fusion of the living millimeter wave signal and the living audio signal, and acquiring the fusion response diagram of the living voice signal may further include step 701 and step 702.

Step 701 may include generating a millimeter wave response diagram and an audio response diagram based on the living millimeter wave signal and the living audio signal, respectively.

Step 702 may include fusing the millimeter wave response diagram and the audio response diagram, and acquiring the fusion response diagram of the living voice signal.

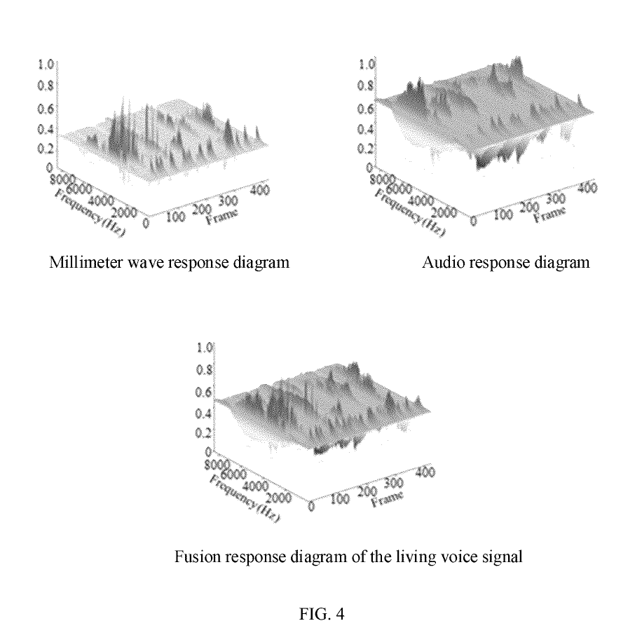

In an embodiment, referring to FIG. 4, a discriminative correlation filter may be employed to generate a millimeter wave response diagram and an audio response diagram based on the living millimeter wave signal and the living audio signal, respectively. Specifically, the correlation filter may track and learn the effective features of the target by the frame streams, and the target may be a spectral energy trajectory of a voice or a wireless signal. The correlation filter may model a region of interest and generate a response diagram to track target change in time and space. In the process of tracking changes in the spectral energy trajectory, the correlation filter may gradually generate a response diagram, the generated response diagram may be adaptively adjusted with weights to enhance speaker-specific features in low and high frequencies related to articulatory habits and vocal organs, and redundancies and ambient noises related to voice contents may be assigned low weights to suppress irrelevant information. Then, the millimeter wave response diagram and the audio response diagram may be fused, and the fusion response diagram of the living voice signal may be acquired. Specifically, segmented convolution of the millimeter wave response diagram and the audio response diagram may produce fusion features, and a convolutional fusion operation may enhance the correlation between the millimeter wave and the audio. The final fusion response diagram of the living voice signal may still remain features originating from the millimeter wave and the audio individually.

In the present embodiment, the millimeter wave response diagram and the audio response diagram may be generated based on the living millimeter wave signal and the living audio signal, respectively, and the millimeter wave response diagram and the audio response diagram may be fused to acquire the fusion response diagram of the living voice signal. This may enhance the correlation between the millimeter wave and the audio by exploiting the correlation connected within the two, and mitigate negative effects of cross-modal irrelevant interference.

In an embodiment, the performing identity recognition based on the fusion response diagram of the living voice signal may further include inputting the fusion response diagram of the living voice signal into an identity recognition network, and acquiring an identity label of the user. The identity recognition network may include a channel attention module and a spatial attention module.

In an embodiment, the fusion response diagram of the living voice signal may be input into the identity recognition network. The identity recognition network may be an attentional residual network that utilizes a residual neural network as a backbone model and introduces two attention-based blocks, including the channel attention module and a spatial attention module. In each residual module of the residual neural network, an Efficient Attention Layer (ECA) may be introduced. The ECA may be an attention-based block including convolutional layers designed to imitate interdependencies between convolutional feature channels. The ECA may apply global average pooling (GAP) to learn contextual information in all receptive domains of the network, instead of learning a limited number of local domains as related convolutional layers do. Based on information from all channels, the ECA may enable the network to focus on capturing more important regions by adaptive channel attention. It may be assumed that an output of a convolutional layer is X=[x₁, x₂, . . . , x_{c}], XϵR^{H×W×C}, H, W, and C are width, height and channel dimensions, respectively, and x_{c} refers to a channel feature produced by an c-th filter in the convolutional layer. Then, the GAP may be applied to build a channel feature mode Z=[z₁, z₂, . . . , z_{c}], ZϵR^{1×1×C}, an c-th element in Z may be obtained by the following formula.

$${z}_{c} = G A P ( {x}_{c} ) = \frac{1}{H \times W} {\sum }_{i}^{H} {\sum }_{j}^{W} {x}_{c} ( i , j )$$

The channel feature mode Z may include statistics of all channels. An attentional feature may be calculated as follows:

A=σ(C1Dₖ(Z))

A=[α₁, α₂, . . . , α_{c}], AϵR^{1×1×C}, σ represents an activation function, and C1Dₖ represents a one-dimensional convolution with a kernel size denoted as k.

A final output of the ECA denoted as \tilde{X} may be obtained by dot-multiplying channels between X and A.

\tilde{X}=A⊙X

⊙ represents a scalar multiplication. The attentional feature A may include dynamic channel information that is continuously optimized during an iterative process.

A typical residual block and an ECA may be connected in series as a basic module of a backbone network, which may be formulated as:

Y= [symbol] (ECA( [symbol] (X,W_{C})),W_{C})+X

A function [symbol] (*, W_{C}) represents multiple convolutional layers configured to capture features, Y represents a final output of the residual block, and ECA(-) represents the ECA. An operation [symbol] +X represents a shortcut connection. Outputs of multiple successive convolutional layers may flow to the ECA, after obtaining a result of attention computation, a shortcut connection may add inputs of the residual block and the result of the ECA to obtain the final output.

In addition to ECA, feature extraction capability of the attentional residual network may also be determined by the channel attention module and the spatial attention module. Nature of the attentional modules has been widely validated to help neural networks understand the “content” and “location” in the channels and space of feature diagrams. Specifically, the channel attention module and the spatial attention module may guide the residual network in selecting and enhancing meaningful knowledge in a hybrid feature diagram. In a channel attention module of the attention residual network, an input feature diagram may be given denoted as F E R^{H×W×C} with a height denoted as H, a width denoted as W, and C channel. The channel attention module may aggregate multiple channel attention modules and pool channel-space information of the feature diagram by an average pooling Pool_{Avg} operation and a maximum pooling Pool_{Max} operation as shown in the following function.

$${F}_{c} = δ ( Conv ( {Pool}_{Avg} ( F ) ) + Conv ( {Pool}_{Max} ( F ) ) )$$

δ(-) represents a ReLu function, Conv represents a one-dimensional convolution with kernel-size of 1×1, and Fc represents a channel attention diagram.

Different from the channel attention module, the spatial attention module may generate a spatial attention diagram denoted as Fₛ, positions of emphasis or suppression may be coded as shown in the following formula.

$${F}_{s} = δ ( {Conv}_{3 \times 3} ( [ {Pool}_{Avg} ( F ) ; {Pool}_{Max} ( F ) ] ) )$$

Mean ensemble features and maximum ensemble features of each channel may be concatenated and convolved by a convolutional layer to produce a two-dimensional spatial attention diagram. The channel attention module may guide the residual neural network to select and enhance meaningful knowledge in the hybrid feature diagram. The spatial attention module may generate a relational diagram of spatial attention mapping, which may encode locations of favorable or harmful features, help the network learn effective feature locations and avoid harmful features. In the present embodiment, the channel attention module and the spatial attention module may be placed successively after each residual block to improve identity recognition performance of the network. The identity recognition network may include four residual blocks embedded with channel attention modules and spatial attention modules. A last layer of the network may be connected to an average pooling layer with a kernel size of 7 and 512 channels and a linear layer with two output units. The fusion response diagram of the living voice signal acquired after the previous processing may be input into this network and an output may be acquired as a label representing identity of the user.

In the present embodiment, the fusion response diagram of the living voice signal may be input into the identity recognition network to acquire an identity label of the user. This may accurately output identity of the user, and ensure efficient and accurate identification of the user in any scene.

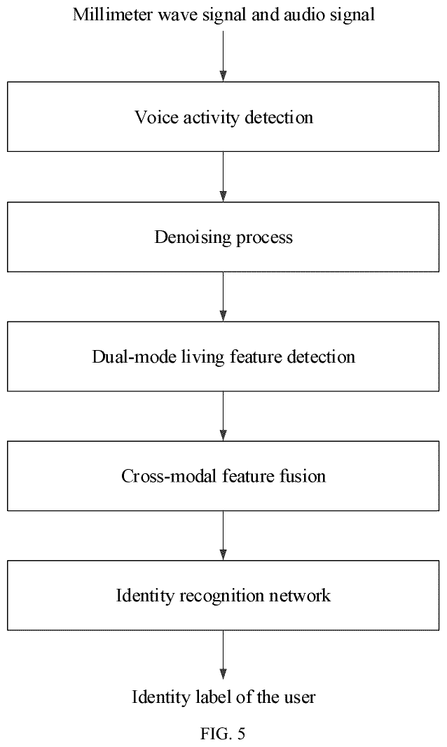

Specific implementation steps of the identity recognition method may be described below in terms of a specific embodiment. Referring to FIG. 5, step 801 includes obtaining a signal to be identified which includes a millimeter wave signal and an audio signal; and step 802 includes performing voice activity detection of the millimeter wave signal and the audio signal, and acquiring a millimeter wave signal and an audio signal with voice activity. Specifically, step 803 includes sampling the millimeter wave signal and the audio signal, and acquiring sampled millimeter wave signals and sampled audio signals; step 804 includes obtaining a phase of the sampled millimeter wave signals and determining phase difference between sampled millimeter wave signals with the same frequency; and step 805 includes performing low-pass filtering based on the phase difference and the sampled audio signals, and acquiring the millimeter wave signal and the audio signal with voice activity. Step 806 includes performing denoising of the millimeter wave signal and the audio signal with voice activity, and acquiring a denoised millimeter wave signal and a denoised audio signal. Specifically, step 807 includes decomposing the millimeter wave signal and the audio signal with voice activity, and acquiring millimeter wave sub-signals and audio sub-signals; step 808 includes calculating correlation based on the millimeter wave sub-signals and the audio sub-signals, and screening the millimeter wave sub-signals and the audio sub-signals based on the correlation; and step 809 includes recombining screened millimeter wave sub-signals and screened audio sub-signals, and acquiring the denoised millimeter wave signal and the denoised audio signal.

Then, step 810 includes performing living feature detection based on the millimeter wave signal and the audio signal, and acquiring a living millimeter wave signal and a living audio signal. Specifically, step 811 includes extracting living feature of millimeter wave and living feature of audio based on the millimeter wave signal and the audio signal, respectively; step 812 includes calculating similarity coefficients based on the living feature of millimeter wave and the living feature of audio, and generating a dual-mode reference signal based on the similarity coefficients; and step 813 includes inputting the dual-mode reference signal into a classification model, and acquiring the living millimeter wave signal and the living audio signal. The classification model is trained by using a standard data set.

Then, step 814 includes performing feature fusion of the living millimeter wave signal and the living audio signal, and acquiring a fusion response diagram of a living voice signal. Specifically, step 815 includes generating a millimeter wave response diagram and an audio response diagram based on the living millimeter wave signal and the living audio signal, respectively; and step 816 includes fusing the millimeter wave response diagram and the audio response diagram, and acquiring the fusion response diagram of the living voice signal.

Finally, step 817 includes performing identity recognition based on the fusion response diagram of the living voice signal. Specifically, step 818 includes inputting the fusion response diagram of the living voice signal into an identity recognition network, and acquiring an identity label of the user. The identity recognition network includes a channel attention module and a spatial attention module.

It should be appreciated that while individual steps in the flowcharts involved in the embodiments as described above are shown sequentially as indicated by the arrows, these steps are not necessarily executed sequentially in the order indicated by the arrows. Unless expressly stated herein, no strict order limitation is on the execution of these steps, and these steps may be executed in other orders. Moreover, at least a portion of the steps in the flowchart involved in the embodiments as described above may include multiple steps or multiple phases, which are not necessarily executed at the same moment of completion, but may be executed at different moments, and the order of execution of these steps or phases is not necessarily sequential, but may be performed in turn or alternately with at least a portion of the other steps or steps in the other steps.

Based on the same inventive concepts, the present disclosure further provides an identity recognition apparatus for implementing the identity recognition methods described above. The implementation to solve the problem provided by the apparatus is similar to the implementation documented in the method described above, so specific limitations in one or more embodiments of the identity recognition apparatus provided below can be found in the limitations for the identity recognition methods described above, and will not be repeated herein.

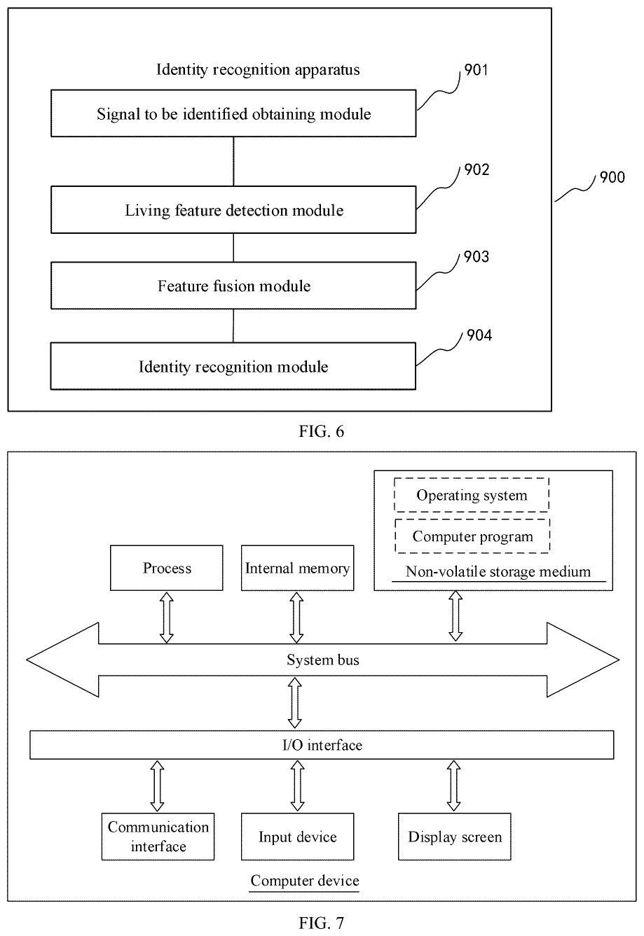

In an embodiment, referring to FIG. 6, an identity recognition apparatus 900 is provided, including a signal to be identified obtaining module 901, a living feature detection module 902, a feature fusion module 903, and an identity recognition module 904.

The signal to be identified obtaining module 901 is configured for obtaining a signal to be identified which comprises a millimeter wave signal and an audio signal.

The living feature detection module 902 is configured for performing living feature detection based on the millimeter wave signal and the audio signal, and acquiring a living millimeter wave signal and a living audio signal.

The feature fusion module 903 is configured for performing feature fusion of the living millimeter wave signal and the living audio signal, and acquiring a fusion response diagram of a living voice signal.

The identity recognition module 904 is configured for performing identity recognition based on the fusion response diagram of the living voice signal.

The identity recognition apparatus 900 further includes a voice activity detection and denoising module.

In an embodiment, the voice activity detection and denoising module is configured for performing voice activity detection of the millimeter wave signal and the audio signal, and acquiring a millimeter wave signal and an audio signal with voice activity; and performing denoising of the millimeter wave signal and the audio signal with voice activity, and acquiring a denoised millimeter wave signal and a denoised audio signal.

In an embodiment, the voice activity detection and denoising module is further configured for sampling the millimeter wave signal and the audio signal, and acquiring sampled millimeter wave signals and sampled audio signals; obtaining a phase of the sampled millimeter wave signals and determining phase difference between sampled millimeter wave signals with the same frequency; and performing low-pass filtering based on the phase difference and the sampled audio signals, and acquiring the millimeter wave signal and the audio signal with voice activity.

In an embodiment, the voice activity detection and denoising module is further configured for decomposing the millimeter wave signal and the audio signal with voice activity, and acquiring millimeter wave sub-signals and audio sub-signals; calculating correlation based on the millimeter wave sub-signals and the audio sub-signals, and screening the millimeter wave sub-signals and the audio sub-signals based on the correlation; and recombining screened millimeter wave sub-signals and screened audio sub-signals, and acquiring the denoised millimeter wave signal and the denoised audio signal.

In an embodiment, the living feature detection module 902 is further configured for extracting living feature of millimeter wave and living feature of audio based on the millimeter wave signal and the audio signal, respectively; calculating similarity coefficients based on the living feature of millimeter wave and the living feature of audio, and generating a dual-mode reference signal based on the similarity coefficients; and inputting the dual-mode reference signal into a classification model, acquiring the living millimeter wave signal and the living audio signal. The classification model is trained by using a standard data set.

In an embodiment, the feature fusion module 903 is further configured for generating a millimeter wave response diagram and an audio response diagram based on the living millimeter wave signal and the living audio signal, respectively; and fusing the millimeter wave response diagram and the audio response diagram, and acquiring the fusion response diagram of the living voice signal.

In an embodiment, the identity recognition module 904 is further configured for inputting the fusion response diagram of the living voice signal into an identity recognition network, and acquiring an identity label of the user. The identity recognition network includes a channel attention module and a spatial attention module.

Various modules in the identity recognition apparatus 900 described above may be implemented in whole or in part by software, hardware, and combinations thereof. Each of the above modules may be embedded in or independent of a processor in a computer device in the form of hardware, or may be stored in a memory in the computer device in the form of software so as to be invoked by the processor to perform operations corresponding to each of the above modules.

In an embodiment, a computer device is provided. The computer device may be a terminal, whose internal structure diagram may be shown in FIG. 7. The computer device includes a processor, a memory, a communication interface, a display, and an input device connected via a system bus. The processor of the computer device is configured to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The communication interface of the computer device is configured for communicating with an external terminal in a wired or wireless manner, and the wireless manner is realized via WIFI, mobile cellular networks, NFC (Near Field Communication) or other technologies. The computer program is executed by the processor to implement an identity recognition method. The display of the computer device may be a liquid crystal display or an e-ink display, and the input device of the computer device may be a touch layer covered on the display, a button, a trackball, or a touchpad provided on a housing of the computer device, or an external keyboard, a touchpad, or a mouse.

It would be appreciated by one skilled in the art that the structure illustrated in FIG. 7 is only a block diagram of a portion of the structure relevant to the present disclosure, does not constitute a limitation on the computer device to which the present disclosure is applied, and that a specific computer device may include more or fewer components than those shown in the FIGs, or a combination of some of the components, or have a different arrangement of components.

In an embodiment, the present disclosure further provides a computer device. The computer device includes a processor and a memory, the memory stores a computer program, and the computer program is executable by the processor to implement the steps of the identity recognition method in the above embodiments.

In an embodiment, the present disclosure further provides a computer-readable storage medium having stored a computer program, the computer program is executable by a processor to implement the steps of the identity recognition method in the above embodiments.

In an embodiment, the present disclosure further provides a computer program product, including a computer program. The computer program is executable by a processor to implement the steps of the identity recognition method in the above embodiments.

It should be noted that the user information (including but not limited to user device information, user personal information, etc.) and data (including but not limited to data used for analysis, data stored, data displayed, etc.) involved in the present disclosure have been authorized by the user or have been fully authorized by parties.

One skilled in the art may appreciate that achieving all or part of the processes in the methods of the above embodiments is possible by means of a computer program to instruct the associated hardware to do so, and that the computer program may be stored in a non-volatile computer-readable storage medium, when the computer program is executed, the processes of the embodiments of the various methods described above may be included. Any reference to a memory, database, or other medium used in the embodiments provided in the present disclosure may include at least one of non-volatile or volatile memories. Non-volatile memories may include a Read-Only Memory (ROM), a magnetic tape, a floppy disc, a flash memory, an optical memory, a high-density embedded non-volatile memory, a Resistance-Resistive Memory (ReRAM), a Magneto resistive Random Access Memory (MRAM), a Ferroelectric Random Access Memory (FRAM), a Phase Change Memory (PCM), a Graphene Memory and so on. The volatile memory may include a Random Access Memory (RAM) or an external cache memory, and the like. As an illustration and not as a limitation, the RAM may be in various forms, such as Static Random Access Memory (SRAM) or Dynamic Random Access Memory (DRAM), and the like. The databases involved in the embodiments provided in the present disclosure may include at least one of a relational database or a non-relational database. The non-relational database may include a blockchain-based distributed database and the like, without limitation. The processor involved in the embodiments provided in the present disclosure may be a general-purpose processor, a central processing unit, a graphics processor, a digital signal processor, a programmable logician, a data processing logician based on quantum computing, and the like, without limitation.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. An identity recognition method, comprising:
obtaining a signal to be identified which comprises a millimeter wave signal and an audio signal;
performing living feature detection based on the millimeter wave signal and the audio signal, and acquiring a living millimeter wave signal and a living audio signal;
performing feature fusion of the living millimeter wave signal and the living audio signal, and acquiring a fusion response diagram of a living voice signal; and
performing identity recognition based on the fusion response diagram of the living voice signal.

2. The identity recognition method of claim 1, wherein before the performing living feature detection based on the millimeter wave signal and the audio signal, and acquiring the living millimeter wave signal and the living audio signal, the method further comprises:
performing voice activity detection of the millimeter wave signal and the audio signal, and acquiring a millimeter wave signal and an audio signal with voice activity; and
performing denoising of the millimeter wave signal and the audio signal with voice activity, and acquiring a denoised millimeter wave signal and a denoised audio signal.

3. The identity recognition method of claim 2, wherein the performing voice activity detection of the millimeter wave signal and the audio signal, and acquiring the millimeter wave signal and the audio signal with voice activity further comprises:
sampling the millimeter wave signal and the audio signal, and acquiring sampled millimeter wave signals and sampled audio signals;
obtaining a phase of the sampled millimeter wave signals and determining phase difference between sampled millimeter wave signals with the same frequency; and
performing low-pass filtering based on the phase difference and the sampled audio signals, and acquiring the millimeter wave signal and the audio signal with voice activity.

4. The identity recognition method of claim 2, wherein the performing denoising of the millimeter wave signal and the audio signal with voice activity, and acquiring the denoised millimeter wave signal and the denoised audio signal further comprises:
decomposing the millimeter wave signal and the audio signal with voice activity, and acquiring millimeter wave sub-signals and audio sub-signals;
calculating correlation based on the millimeter wave sub-signals and the audio sub-signals, and screening the millimeter wave sub-signals and the audio sub-signals based on the correlation; and
recombining screened millimeter wave sub-signals and screened audio sub-signals, and acquiring the denoised millimeter wave signal and the denoised audio signal.

5. The identity recognition method of claim 1, wherein the performing living feature detection based on the millimeter wave signal and the audio signal, and acquiring the living millimeter wave signal and the living audio signal further comprises:
extracting living feature of millimeter wave and living feature of audio based on the millimeter wave signal and the audio signal, respectively;
calculating similarity coefficients based on the living feature of millimeter wave and the living feature of audio, and generating a dual-mode reference signal based on the similarity coefficients; and
inputting the dual-mode reference signal into a classification model, and acquiring the living millimeter wave signal and the living audio signal, wherein the classification model is trained by using a standard data set.

6. The identity recognition method of claim 1, wherein the performing feature fusion of the living millimeter wave signal and the living audio signal, and acquiring the fusion response diagram of the living voice signal further comprises:
generating a millimeter wave response diagram and an audio response diagram based on the living millimeter wave signal and the living audio signal, respectively; and
fusing the millimeter wave response diagram and the audio response diagram, and acquiring the fusion response diagram of the living voice signal.

7. The identity recognition method of claim 1, wherein the performing identity recognition based on the fusion response diagram of the living voice signal further comprises:
inputting the fusion response diagram of the living voice signal into an identity recognition network, and acquiring an identity label of the user, wherein the identity recognition network comprises a channel attention module and a spatial attention module.

8. An identity recognition apparatus, comprising:
means for obtaining a signal to be identified which comprises a millimeter wave signal and an audio signal;
means for performing living feature detection based on the millimeter wave signal and the audio signal, and acquiring a living millimeter wave signal and a living audio signal;
means for performing feature fusion of the living millimeter wave signal and the living audio signal, and acquiring a fusion response diagram of a living voice signal; and
means for performing identity recognition based on the fusion response diagram of the living voice signal.

9. A computer device, comprising a processor and a memory, the memory storing a computer program, wherein the computer program is executable by the processor to implement the steps of the identity recognition method of claim 1.

10. The computer device of claim 9, wherein before the performing living feature detection based on the millimeter wave signal and the audio signal, and acquiring the living millimeter wave signal and the living audio signal, the method further comprises:
performing voice activity detection of the millimeter wave signal and the audio signal, and acquiring a millimeter wave signal and an audio signal with voice activity; and
performing denoising of the millimeter wave signal and the audio signal with voice activity, and acquiring a denoised millimeter wave signal and a denoised audio signal.

11. The computer device of claim 10, wherein the performing voice activity detection of the millimeter wave signal and the audio signal, and acquiring the millimeter wave signal and the audio signal with voice activity further comprises:
sampling the millimeter wave signal and the audio signal, and acquiring sampled millimeter wave signals and sampled audio signals;
obtaining a phase of the sampled millimeter wave signals and determining phase difference between sampled millimeter wave signals with the same frequency; and
performing low-pass filtering based on the phase difference and the sampled audio signals, and acquiring the millimeter wave signal and the audio signal with voice activity.

12. The computer device of claim 10, wherein the performing denoising of the millimeter wave signal and the audio signal with voice activity, and acquiring the denoised millimeter wave signal and the denoised audio signal further comprises:
decomposing the millimeter wave signal and the audio signal with voice activity, and acquiring millimeter wave sub-signals and audio sub-signals;
calculating correlation based on the millimeter wave sub-signals and the audio sub-signals, and screening the millimeter wave sub-signals and the audio sub-signals based on the correlation; and
recombining screened millimeter wave sub-signals and screened audio sub-signals, and acquiring the denoised millimeter wave signal and the denoised audio signal.

13. The computer device of claim 9, wherein the performing living feature detection based on the millimeter wave signal and the audio signal, and acquiring the living millimeter wave signal and the living audio signal further comprises:
extracting living feature of millimeter wave and living feature of audio based on the millimeter wave signal and the audio signal, respectively;
calculating similarity coefficients based on the living feature of millimeter wave and the living feature of audio, and generating a dual-mode reference signal based on the similarity coefficients; and
inputting the dual-mode reference signal into a classification model, and acquiring the living millimeter wave signal and the living audio signal, wherein the classification model is trained by using a standard data set.

14. The computer device of claim 9, wherein the performing feature fusion of the living millimeter wave signal and the living audio signal, and acquiring the fusion response diagram of the living voice signal further comprises:
generating a millimeter wave response diagram and an audio response diagram based on the living millimeter wave signal and the living audio signal, respectively; and
fusing the millimeter wave response diagram and the audio response diagram, and acquiring the fusion response diagram of the living voice signal.

15. The computer device of claim 9, wherein the performing identity recognition based on the fusion response diagram of the living voice signal further comprises:
inputting the fusion response diagram of the living voice signal into an identity recognition network, and acquiring an identity label of the user, wherein the identity recognition network comprises a channel attention module and a spatial attention module.

16. A computer-readable storage medium having stored a computer program, wherein the computer program is executable by a processor to implement the steps of the identity recognition method of claim 1.

17. The computer-readable storage medium of claim 16, wherein before the performing living feature detection based on the millimeter wave signal and the audio signal, and acquiring the living millimeter wave signal and the living audio signal, the method further comprises:
performing voice activity detection of the millimeter wave signal and the audio signal, and acquiring a millimeter wave signal and an audio signal with voice activity; and
performing denoising of the millimeter wave signal and the audio signal with voice activity, and acquiring a denoised millimeter wave signal and a denoised audio signal.

18. The computer-readable storage medium of claim 17, wherein the performing voice activity detection of the millimeter wave signal and the audio signal, and acquiring the millimeter wave signal and the audio signal with voice activity further comprises:
sampling the millimeter wave signal and the audio signal, and acquiring sampled millimeter wave signals and sampled audio signals;
obtaining a phase of the sampled millimeter wave signals and determining phase difference between sampled millimeter wave signals with the same frequency; and
performing low-pass filtering based on the phase difference and the sampled audio signals, and acquiring the millimeter wave signal and the audio signal with voice activity.

19. The computer-readable storage medium of claim 17, wherein the performing denoising of the millimeter wave signal and the audio signal with voice activity, and acquiring the denoised millimeter wave signal and the denoised audio signal further comprises:
decomposing the millimeter wave signal and the audio signal with voice activity, and acquiring millimeter wave sub-signals and audio sub-signals;
calculating correlation based on the millimeter wave sub-signals and the audio sub-signals, and screening the millimeter wave sub-signals and the audio sub-signals based on the correlation; and
recombining screened millimeter wave sub-signals and screened audio sub-signals, and acquiring the denoised millimeter wave signal and the denoised audio signal.

20. The computer-readable storage medium of claim 16, wherein the performing living feature detection based on the millimeter wave signal and the audio signal, and acquiring the living millimeter wave signal and the living audio signal further comprises:
extracting living feature of millimeter wave and living feature of audio based on the millimeter wave signal and the audio signal, respectively;
calculating similarity coefficients based on the living feature of millimeter wave and the living feature of audio, and generating a dual-mode reference signal based on the similarity coefficients; and
inputting the dual-mode reference signal into a classification model, and acquiring the living millimeter wave signal and the living audio signal, wherein the classification model is trained by using a standard data set.
